(19) United States
(12) Patent Application Publication
(10) Pub. No.: US 2011/0138191 A1
(43) Pub. Date: Jun. 9, 2011

(54) SECURE DATA CACHE

(76) Inventor: Michael Bond, Cambridge (GB)

(21) Appl. No.: 12/937,980

(22) PCT Filed: Apr. 29, 2009
(86) PCT No.: PCT/GB09/50438

§ 371 Date: Dec. 21, 2010

(30) Foreign Application Priority Data
Apr. 29, 2008 (GB) 0807753.9

(51) Int. Cl. G06F 12/14

(52) U.S. Cl. 713/189

(57) ABSTRACT

This invention is generally concerned with methods, apparatus and computer program code for securely caching\data, in particular for caching data stored on smart card systems such as those used in ICAO-compliant EU electronic passports. A caching system for providing a secure data cache for data stored in an electronic document, the comprising: an input to receive data to be cached; a processor configured to use all or part of said received data to calculate a unique cryptographic key for said data; encrypt all or part of said data with said unique cryptographic key; and discard said unique cryptographic key after encryption and an output to send said encrypted data to a data cache, with decryption of encrypted data requiring said unique cryptographic key to be recalculated from said electronic document whereby said data cache is secure. Use of such a cache dramatically speeds up the inspection process, by bypassing the need to read data entirely, except for during the first inspection.

### CROSS REFERENCE TO RELATED APPLICATION

The present application claims priority to (is a national stage filing of) PCT Application PCT/GB2009/050438 filed Apr. 29, 2009, which claims priority to British Patent Application No. GB0807753.9 filed Apr. 29, 2008. The entirety of each of the aforementioned references is incorporated herein by reference for all purposes.

### BACKGROUND OF THE INVENTION

This invention is generally concerned with methods, apparatus and computer program code for securely caching data, in particular for storing private and/or security sensitive data, such as biometric data from electronic identity documents.

Electronic identity documents are physical ID documents augmented with electronically stored information, for example, augmented with smartcard chips with contacted or contactless interfaces. Examples include ePassports, national ID cards, driving licences and health cards. The smartcard chip may perform a variety of functions including authenticating the users identity, providing counterfeit resistance, and storage of data. Crucially, many electronic identity schemes use smartcard chips with storage as a distributed database of personal and biometric data for the identity card holder. Each card could store up to 80 KB of data.

The International Civil Aviation Organisation (ICAO) has produced a set of specifications for storage of biometric data on Machine Readable Travel Documents (MRTD), formatted in a way which protects their integrity with a digital signature from the issuing authority. The format of the stored data and associated meta-information comprises the ICAO “Logical Data Structure” (LDS).

Whilst there are many advantages of using a smartcard system as a distributed database, there are also drawbacks. In particular, it is time consuming to read data from smartcard chips due to the limitations on bandwidth of the contactless interface. It can take in excess often seconds to read biometric data groups from an electronic identity document. With poorly matched chip and reader software, it may take in excess of 20 seconds. Even the contact interface to a smartcard does not support particularly high data rates, and the amount of personal and biometric data that may need to be stored is rapidly growing as different biometric schemes (fingerprint, iris etc) compete to become established.

An alternative to a smart chip based scheme for identity documents is to maintain a central store of data. Public key technology is straightforward to apply in either scenario to allow verifiers to check the integrity of data retrieved from the central store. However for the store itself there are considerable security and privacy concerns. Additionally there are connectivity issues to consider, when identity documents must be verified in remote environments, or if the central database suffers communication failure.

The content of such databases would need to be subject to data protection laws, and is liable to abuse and perversion of purpose (legal use for a purpose other than the original reason for which it was originally collected). Whilst states are free to pursue their own central biometric collection programs, the EU has required that the sensitive biometric data retrieved from EU passports by member states must not be stored by inspection systems.

Methods of creating encrypted stores of data are known from WO98/47259 and U.S. Pat. No. 6,577,735.

Hence, there exists a need in the art for systems and methods to mitigate the aforementioned limitations.

### BRIEF SUMMARY OF THE INVENTION

This invention is generally concerned with methods, apparatus and computer program code for securely caching data, in particular for storing private and/or security sensitive data, such as biometric data from electronic identity documents.

According to one aspect of the invention, there is provided a method of securely caching data stored in an electronic document, the method comprising: reading data from said electronic document, using all or part of said data to calculate a unique cryptographic key for said data; encrypting all or part of said data with said unique cryptographic key; discarding said unique cryptographic key after encryption and caching said encrypted data in a data cache, with decryption of encrypted data requiring the presence of said electronic document to recalculate said unique cryptographic key from said electronic document.

According to another aspect of the invention, there is provided a caching system for providing a secure data cache for data stored in an electronic document, the caching system comprising: an input to receive data to be cached; a processor configured to use all or part of said received data to calculate a unique cryptographic key for said data; encrypt all or part of said data with said unique cryptographic key; and discard said unique cryptographic key after encryption and an output to send said encrypted data to a data cache, with decryption of encrypted data requiring the presence of said electronic document to recalculate said unique cryptographic key from said electronic document whereby said data cache is secure.

Said electronic document may be an electronic identity document comprising biometric data and the method may comprise reading, encrypting and caching all or part of said biometric data. Use of such a cache dramatically speeds up the inspection process, by bypassing the need to read data entirely, except for during the first inspection. The above method and caching system create an encrypted cache of biometric data where each entry may only be accessed in the presence of the original identity document from which it was sourced. The use of such an encrypted cache represents a viable middle ground between a fully distributed scheme in which no data is stored and a fully centralized scheme in which all data is stored centrally. Local caching of data may occur for data that has been read from identity documents, on local, national or even international level.

The data may be stored in the cache under a pseudonym or anonymous identifier whereby said data is not personally identifiable in the cache. The identifier may be considered a lookup key to the data in that it enables an inspection system to look-up the data but the identifier is not intended to be a cryptographic key. Only part of the data may be stored in the cache, for example, the head of each data file may be omitted. In this way, it would be infeasible to retrieve the data without access to the original document. Said electronic document may comprise summary data, i.e. a file summarizing the data stored therein. Said summary data may include cryptographic hashes of other data stored, or a digital signature and all or part of said summary data may be used to calculate a unique cryptographic key for said biometric data. For example, a key derivation function may be applied to this summary data to generate a secure key for encrypting data from the passport. Such a key may only be recreated from the summary data only when the electronic document is present. An identifier derivation function may also be applied to this summary data to generate an identifier for the data.

Said biometric data may comprise facial information and/or fingerprint data and all or part of said summary data, e.g. digital signature, may be used to calculate a unique cryptographic key for said biometric data.

For example, the electronic identity document may be an ICAO-compliant EU electronic passport, which may contain sixteen different data groups of biometric (e.g. facial, fingerprint and/or iris information), biographical and additional information, such as signature data. Any and/or all of these data groups may be cached. Such passports also comprise summary data in the form of a “Document Security Object” (SOD) which is a sort of “summary file” containing a digital signature. The SOD protects the integrity of the information stored on the ePassport and is read before any large data groups are read from an ePassport. The SOD contains high entropy unpredictable data, and thus the unique cryptographic key may be derived from the document security object, .e.g. from the digital signature.

Said unique cryptographic key may be a hash value. Encrypting all or part of said data may comprise salting said data. Deriving a hash value and salting are standard cryptographic techniques. A hash function is a transformation that takes an input and returns a fixed size string which is called the hash value. The hash value may be a concise representation of a longer message or document from which it is computed and is thus sometimes termed a “message digest”. The message digest is a sort of digital fingerprint of the larger document since it is unique to that document. In cryptography, a salt comprises random bits that are used as one of the inputs to a cryptographic operation, in order to increase the entropy of the input.

In the specific example, of ePas sports, the SOD includes hashes of biometric data and the digital signature itself. These hashes may be used to calculate said unique cryptographic key, e.g. half of the hash value may be salted and then hashed using standard best-practice cryptographic techniques.

Some of the data stored in an electronic document may be protected by other mechanisms to prevent unauthorized access to such data. Accordingly, it may not be sufficient to use summary information to calculate the unique cryptographic key since such information effectively caches the result of authorized access for the data. In such circumstances, part of the data itself, e.g. the head of the actual file for the data, may be used to create the unique cryptographic key for the data. In this way, a document issuer can always revoke access to the access controlled data (assuming that the document issuer effectively audits that the secure data cache is properly implemented).

For example, fingerprint data in EU passports is protected from unauthorized access via a security mechanism in the EAC suite called “Terminal Authentication”, which requires an inspection system to demonstrate that it is authorized to recover the data. If the hash of the fingerprint data stored in the SOD is used to calculate the unique cryptographic key, this hash is always available to an ePas sport inspector without undergoing the terminal authentication process. Therefore storing fingerprint data using only the electronic signature in effect caches the (successful) result of terminal authentication. Thus, even if terminal authentication is withdrawn from the inspection system, it is still able to access the fingerprint data. In this example, the biometric data, i.e. fingerprint data, is in the form of an image and the unique cryptographic key for said image may be calculated using part of said image alone or in combination with said electronic signature.

According to another aspect of the invention, there is provided a method of retrieving data on an electronic document from a secure data cache created using the method of any one of the preceding claims, the method of retrieving data comprising: reading some data from said electronic document; using all or part of said read data to recalculate said unique cryptographic key for said electronic document; and retrieving data on said electronic document by decrypting encrypted data for said electronic document in said secure data cache using said recalculated unique cryptographic key.

In other words, the data (except that needed to create the key) on the electronic document is retrieved from the secure data cache and not from the document itself. As explained above, this dramatically speeds up the time required to access the data on the document. It is possible to bypass the need to read all the data, except during the first inspection of the document, i.e. during the creation of the data cache.

Said electronic document may be an electronic identity document comprising biometric data and the method may comprise retrieving said biometric data. The features of such documents set out above also apply to the other aspects of the invention.

According to another aspect of the invention, there is provided a method of verifying or inspecting an electronic document, the method comprising: creating a secure data cache as described above; reading part of the data from said electronic document, using all or part of said read data to recalculate said unique cryptographic key for said electronic document; decrypting encrypted data for said electronic document in said secure data cache using said recalculated unique cryptographic key and verifying said electronic document and its holder using said decrypted data.

According to another aspect of the invention, there is provided a data retrieval system for retrieving information on an electronic document from a secure data cache created by the caching system of any one of claims 13 to 16, the data retrieval system comprising: an inspection system for reading some data from said electronic document; and a processor configured to: use all or part of said read data to recalculate said unique cryptographic key for said data; and decrypt encrypted data in said secure data cache using said recalculated unique cryptographic key, whereby data on said electronic document is retrieved from said secure data cache.

According to another aspect of the invention, there is provided a verification system for verifying an electronic document, the verification system comprising: a secure data cache as described above; an input to receive data from said electronic document; and a processor configured to: use all or part of said received data to recalculate said unique cryptographic key for said data; decrypt encrypted data in said secure data cache using said recalculated unique cryptographic key and verify said electronic document and its holder using said decrypted data.

The verification system may be associated with a secret cryptographic key known only the verification system itself and this secret cryptographic key may be incorporated into the calculation to derive the unique cryptographic key for the data.

The invention further provides processor control code to implement the above-described methods, for example on a general purpose computer system or on a digital signal processor (DSP). The code may be provided on a carrier such as a disk, CD- or DVD-ROM, programmed memory such as read-only memory (Firmware). Code (and/or data) to implement embodiments of the invention may comprise source, object or executable code in a conventional programming language (interpreted or compiled) such as C, or assembly code, code for setting up or controlling an ASIC (Application Specific Integrated Circuit) or FPGA (Field Programmable Gate Array), or code for a hardware description language such as Verilog (Trade Mark) or VHDL (Very high speed integrated circuit Hardware Description Language). As the skilled person will appreciate such code and/or data may be distributed between a plurality of coupled components in communication with one another.

This summary provides only a general outline of some embodiments of the invention. Many other objects, features, advantages and other embodiments of the invention will become more fully apparent from the following detailed description, the appended claims and the accompanying drawings.

### BRIEF DESCRIPTION OF THE DRAWINGS

A further understanding of the various embodiments of the present invention may be realized by reference to the figures which are described in remaining portions of the specification. In the figures, like reference numerals are used throughout several figures to refer to similar components. In some instances, a sub-label consisting of a lower case letter is associated with a reference numeral to denote one of multiple similar components. When reference is made to a reference numeral without specification to an existing sub-label, it is intended to refer to all such multiple similar components.

FIG. 1 is a block diagram overview of an inspection system incorporating a secure data cache;

FIG. 2 is a variation of FIG. 1 for use in an inspection system used in ePassport applications;

FIG. 3 illustrates calculation of a unique cryptographic key for data in the ePassport of FIG. 2;

FIG. 4 is a schematic diagram showing how local, national and international inspection systems communicate with a secure data cache;

FIG. 5 shows a schematic diagram of the components of an inspection system of FIG. 1 or FIG. 2; and

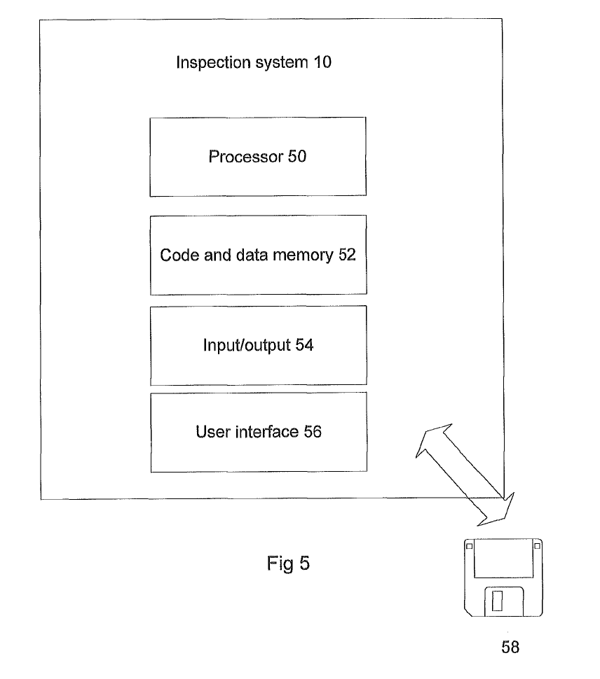

FIG. 6 is a flow chart of the steps in creating a secure data cache, retrieving information therefrom and verifying a document.

### DETAILED DESCRIPTION OF THE INVENTION

This invention is generally concerned with methods, apparatus and computer program code for securely caching data, in particular for storing private and/or security sensitive data, such as biometric data from electronic identity documents.

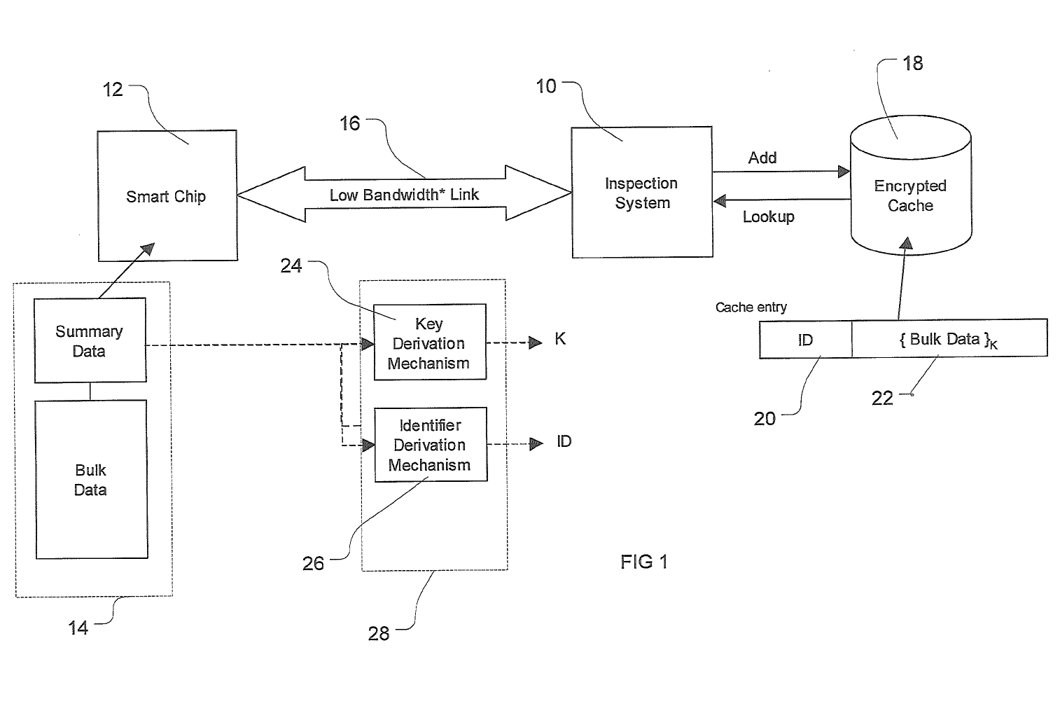

FIG. 1 shows an inspection system 10 for inspecting an electronic document containing a smart chip 12 on which data 14 including summary data and bulk data is stored. The smart chip 12 may have a contacted or contactless interface. The inspection system accesses electronic data held on the smart chip 12 by standard technology which is currently a low bandwidth link 16. Low bandwidth means low bandwidth in proportion to the amount of data than must be transmitted.

The inspection system 10 is also connected to a secure data cache 18 which may be local to the inspection system or may be a shared cache to which the inspection system is connected, e.g. by an online connection. Each entry in the cache comprises an identifier ID 20 and the encrypted bulk data {bulk data}κ22encrypted using a unique cryptographic key K. The communication between the inspection system 10 and the secure data cache 18 is a two-way link so that the inspection system can add entries to the cache and lookup information stored in the cache.

As represented by dotted lines, both the identifier ID and unique cryptographic key K used to encrypt the data are derived from the summary data held on the smart chip. The key is derived using a key derivation mechanism 24 which may be a hash function or other standard cryptographic function applied to the summary data. Similarly, the identifier is derived using an identifier derivation mechanism 26 which may apply a hash function or other similar function to the summary data. Both the key and identifier derivation mechanisms are part of a processor 28 which may be local to or remote from the inspection system.

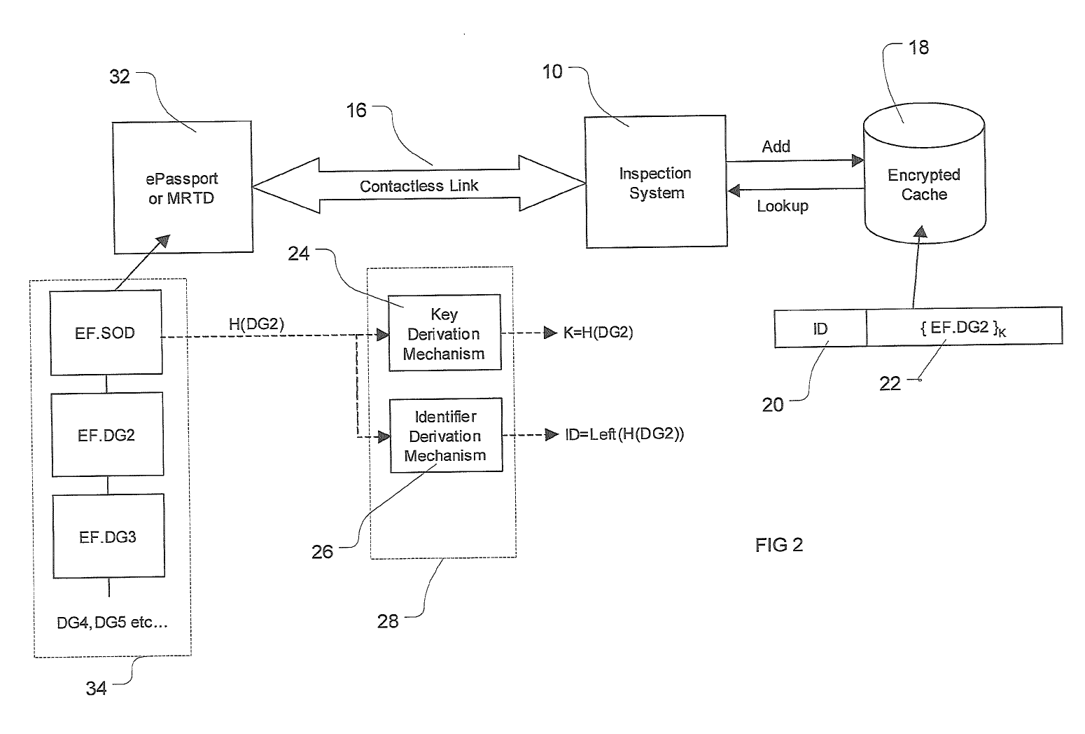

In FIG. 2, the system of FIG. 1 has been adapted for the example of an ICAO-compliant EU electronic passport 32. The data 34 stored on such a passport 32 contains sixteen different groups of biometric, biographical and additional information. Two of the large biometric data groups to be stored on EU Extended Access Control (EAC) compliant ePassports are:

Data Group 2 (DG2)—Facial Information

Data Group 3 (DG3)—Fingerprint Information

Before these large data groups are read from an ePassport, the “Document Security Object” (SOD) is first read. The “Document Security Object” (SO0) is a sort of “summary file” which contains a digital signature and protects the integrity of the information stored on the ePas sport. As the summary file contains high entropy unpredictable data, including hashes of biometric data and the digital signature itself, a key derivation function can be applied to this data to generate a secure key for encrypting data from the passport. Such a key could only be recreated in possession of the summary file.

In the specific example of ePassports, the hash values calculated over each data group can be used as cryptographic keys to encrypt the data group bulk data before caching it. The hash values can also be used as a pseudonym or identifier in order to prevent the data group from being personally identifiable in the database.

In one particular example, DG2 may be securely stored by dividing the hash of the data H(DG2) in half. The first half is used as an identifier ID=left (H(DG2)) to a (non-cryptographic) hash table in order to store the data group. The data group is then encrypted using a cryptographic key derived from the second half of the hash, i.e. K=right(H(DG2)). Standard best-practice cryptographic techniques are used for such encryption, including salting. Example rows in a cache table would contain the following lookup key or identifier and encrypted data:

| | |
|---|---|
| left(hash(DG2)) | encrypt( right(hash(DG2)) , salt\|\|DG2 ) |

In this way, only in possession of the real ePassport (whose Document Security Object contains the hashes of the data groups) can one calculate the key and decrypt the data group. It is infeasible to predict the value of this hash of a biometric data group, even knowing the identity of the citizen from which the data groups have been made. The data is typically a JPEG file, WSQ image or similar image file and such image files are highly redundant encodings from a semantic perspective. Accordingly, they contain a lot of unpredictable data and thus have high entropy.

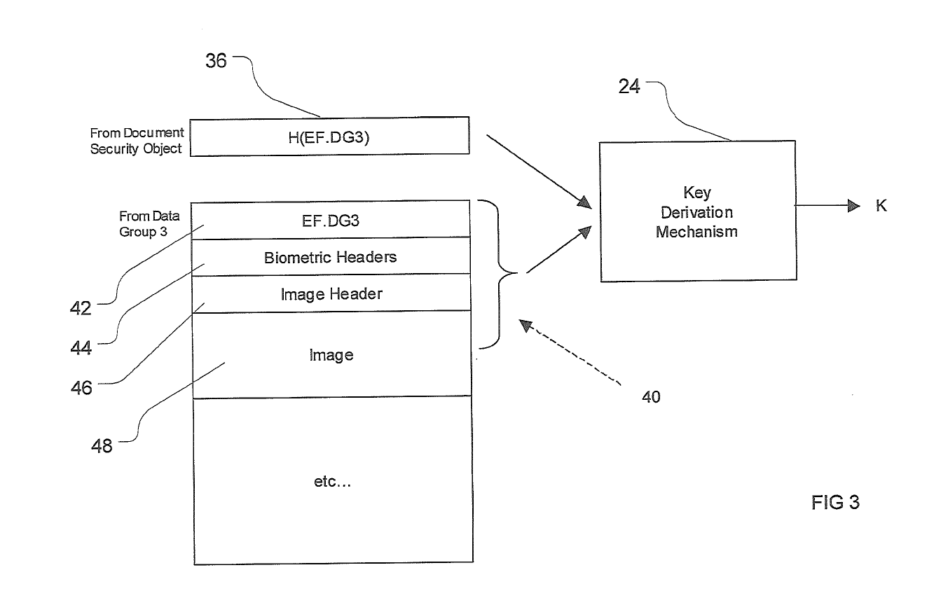

Some smartcard data that an inspection might want to cache is protected by access control mechanisms. For example, fingerprint data in EU passports is stored in data group 3 (DG3) and is protected from unauthorized access via a security mechanism in the EAC suite called “Terminal Authentication”, which requires an inspection system to demonstrate that it is authorized to recover the data. However, the hash of the fingerprint data is available to an ePassport inspector in the document security object without undergoing the terminal authentication process. Therefore storing fingerprint data using the above scheme in effect caches the (successful) result of terminal authentication. In cases where the access control mechanism could be bypassed after the first successful access, FIG. 3 shows how the key derivation mechanism 24 derives key K.

The hash of the data H(EF.DG3) 32 which is available from the document security object is combined with the head of the actual file. It is important to include a large enough head of the file 40 in order to subsume adequate high entropy data into the hash. The amount of head used must extend over the file header 42, the biometric CBEFF headers 44 and image headers 46 and part of the image itself 48. Thus, high entropy data from a summary file which is not subject to access control together with the head of the actual file itself which is subject to access control are used as an input to the key derivation function.

The first couple of hundred bytes of the fingerprint data group are concatenated with the hash of DG3 to make a key which can only be recreated after performing the proper access control procedure. Therefore a document issuer can always revoke another country's access to the access controlled data (assuming that the document issuer effectively audits that the inspector is properly implementing the scheme). In this example, the cache table would contain rows of the following form:

| | |
|---|---|
| left(hash(DG3)) | encrypt( hash(head(DG3)) , saltl]DG3 ) |

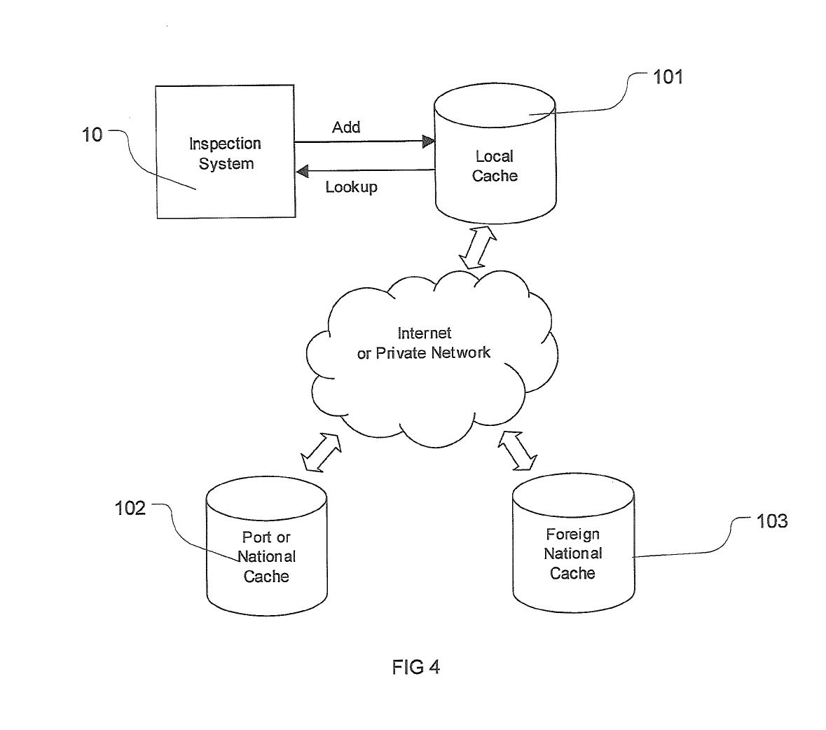

FIG. 4 illustrates how the inspection system 10 may be connected to one or more secure data caches. The inspection system may communicate with a secure data cache in the form of a local cache 101 embedded in the inspection system itself. The inspection system may communicate with an external cache, e.g. a port or national cache 102 or an International cache 103, via the Internet or a private network using standard techniques. For the external caches 102,103, there may be synchronisation over networks to add data to the caches.

Feasibility of such a cache scheme, particularly for offline devices, depends on the storage requirements for data retrieved from the smart chip. To demonstrate the feasibility, take for example the data typically stored on an EU EAC electronic passport:

Facial Image 20 KB

Fingerprint Images 15 KB each (usually two)

This gives a typical maximum of 50 KB of data per passport holder. To store a database of encrypted biometric data for 200 million travellers will require 50 KB*200 million=9.3 terabytes. In practice the distribution of frequency of travel for passport holders is rather skewed. Accordingly, the available cache space can be chosen based on storage prices and operational concerns, with the space in the cache allocated to the most frequent users. There is a wealth of appropriate cache population and replacement algorithms. Multi-layered caching can be performed between local inspection systems, ports-of-entry, national regions or even with international cooperation using synchronisation over the networks.

For portable inspection systems which cannot access external caches via wireless connectivity, a local cache 101 of the most frequent 100,000 travellers' encrypted biometrics could easily be loaded onto a 4 GB flash storage card.

Note again that the cache contains no personally identifiable information, and although it contains encrypted data, once the key is discarded this data is effectively deleted. The actual data is conceptually no more retained on the system than a RAM copy of a biometric is once the power to a PC is switched off.

Two further mechanisms can be used to reduce cache storage requirements, and to control distribution and use of the cache (should a cache creator not wish to share their cache data). First, as the head of each access-controlled data group is read out for inclusion in the storage key derivation process, this head need not be included in the cache entry itself, thus saving several hundred bytes per biometric record (a small saving such as this is magnified when records for billions of passport holders are stored). It also further demonstrates the impossibility of retrieving the biometric data without access to the original document—as some of it is entirely missing.

Second, a secret cryptographic key known only to valid inspection systems can be incorporated as an input to the key derivation function during construction of cache entries and upon retrieval. This makes it impossible for third parties to gain speed-up from accessing cache data without operating an approved inspection system.

Finally, there have been some concerns that if nations need to move to ten fingerprint biometric systems, whilst DG3 three can easily store many more images, it is the entire data group which is hashed, and not individual parts of it. This means that if an inspector desires only to read out the two index fingerprints out of a larger set, the integrity of these images cannot be assured without reading out the entire set. Reading out a ten fingerprint set via a contactless interface could take more than 60 seconds, so the advantages of caching in this context are even further magnified.

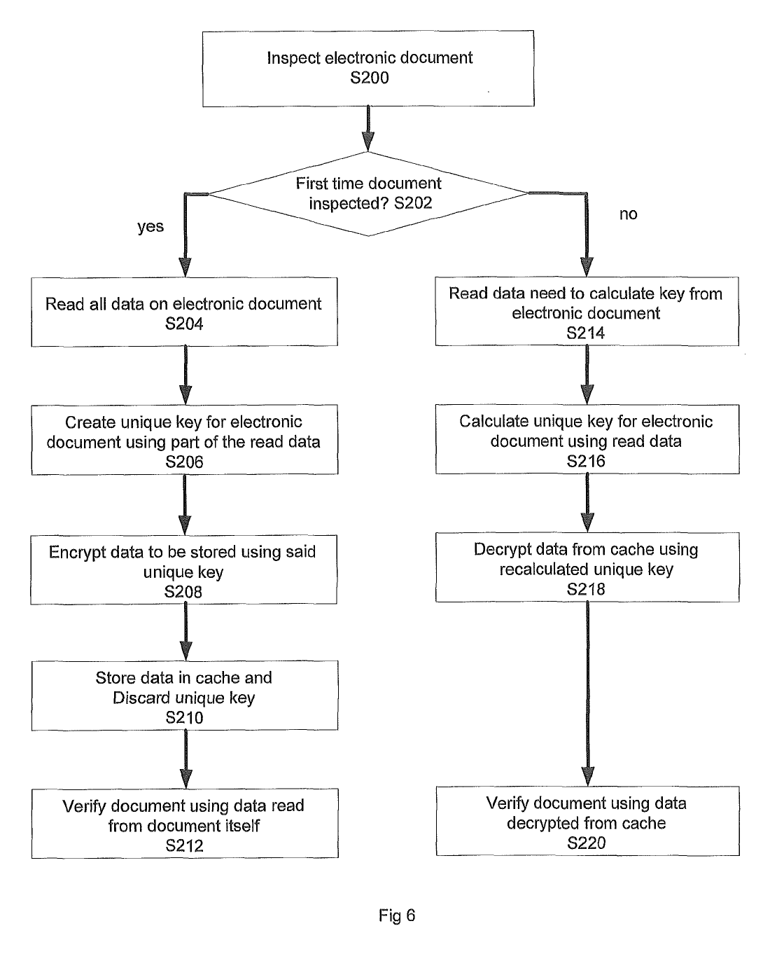

FIG. 6 shows the components of the inspection system. The inspection system 10 comprises a processor 50 coupled to code and data memory 52, an input/output system 54 (for example comprising interfaces to the data cache and/or interfaces to connect to the interface on the smart chip), and to a user interface 56 for example comprising a keyboard and/or mouse. The code and/or data stored in memory 52 may be provided on a removable storage medium 58. In operation the data includes data collected from the electronic identity documents and the code comprises code to process this data to generate the data cache, retrieve data from the cache and/or verify the document in accordance with the procedure shown in FIG. 6, described below.

FIG. 6 shows a flow chart of the various methods using the systems described above. At step S200, an electronic document is inspected by the system and the system determines whether or not this is the first time a document has been inspected at step 202. If this is the first time that the system has seen this document, a secure data cache is created as set out in steps S204 to S210. At step S204, all the data which is to be stored in the data cache is read. At step S206, a unique key for the data to be stored is created using part of the read data, e.g. using the document summary. The data to be stored is then encrypted with this unique key at S208. The encrypted data is stored in a data cache at step S210 and the unique key is discarded by the system. As explained previously, thereafter the data in the cache may only be retrieved when the system is in the presence of the original electronic document.

If the system has previously seen the document (and stored information from the document in the data cache), at step S214, only the data required to recalculate the unique key is read from the document. At step S216, the unique key is calculated from this read data and at step S218, the data in the data cache is decrypted using this key. Data on the electronic document is thus retrieved from the cache and not from the document, whereby the data is more quickly accessed. The method of retrieving data from the cache is thus set out in steps S214 to 218.

Steps S212 and S220 show the step of verifying the document and its holder where a document is seen for the first time or a subsequent time. At step S212, the document is verified using data read from the document itself whereas in contrast, at step S220, the document is verified using data from the cache rather than from the document itself. In both cases, the original document is still required as part of the verification process since it is not possible to access the data in the cache without the original document to calculate the unique key.

The description above describes a mechanism for securely caching smartcard data in inspection systems which read stored data from smartcards. Use of such a mechanism dramatically accelerates the speed of inspecting returning documents by replacing the data transfer phase from the smartcard with a lookup from the cache. Due to the specific security features of the mechanism, the cache does not create a security or privacy risk. The mechanism works by encrypting the cached data under a key derived from high-entropy data stored on the document, and then throwing away the key, so that the cache entry can only be decrypted in the presence of the real document.

No doubt many other effective alternatives will occur to the skilled person. It will be understood that the invention is not limited to the described embodiments and encompasses modifications apparent to those skilled in the art lying within the spirit and scope of the claims appended hereto.

1. A method of securely caching data stored in an electronic document, the method comprising:
reading data from said electronic document,
using all or part of said data to calculate a unique cryptographic key for said data;
encrypting all or part of said data with said unique cryptographic key;
discarding said unique cryptographic key after encryption; and
caching said encrypted data in a data cache, with decryption of encrypted data requiring the presence of said electronic document to recalculate said unique cryptographic key from said electronic document.

2. A method according to claim 1, wherein said electronic document is an electronic identity document comprising biometric data and the method comprises reading, encrypting and caching all or part of said biometric data.

3. A method according to claim 2, wherein said electronic document comprises summary data and the method comprises using all or part of said summary data to calculate a unique cryptographic key for said biometric data.

4. A method according to claim 3, wherein said biometric data comprises facial information and the method comprises using all or part of said summary data to calculate a unique cryptographic key for said facial information.

5. A method according to claim 2, wherein said electronic document comprises digitally signed data and biometric data in the form of an image and the method comprises calculating a unique cryptographic key for said image using part of said image and said digitally signed data.

6. A method according to claim 2, wherein said biometric data comprises an image and the method comprises using part of said image to calculate a unique cryptographic key for said image.

7. A method according to claim 5 or claim 6, wherein said image is a fingerprint data.

8. A method according to claim 1, comprising storing said encrypted data in the cache under an anonymous identifier whereby said data is not personally identifiable in the cache.

9. A method of retrieving data on an electronic document which has been stored as encrypted data in a secure data cache created using the method of claim 1, the method of retrieving data comprising:
reading some data from said electronic document;
using all or part of said read data to recalculate said unique cryptographic key for said encrypted data; and
retrieving data on said electronic document by decrypting encrypted data for said electronic document in said secure data cache using said recalculated unique cryptographic key.

10. A method according to claim 9, wherein said electronic document is an electronic identity document comprising biometric data and the method comprises retrieving said biometric data.

11. A method of verifying an electronic document, the method comprising:
creating a secure data cache as described in claim 1;
reading part of the data from said electronic document, using all or part of said read data to recalculate said unique cryptographic key for said encrypted data;
decrypting encrypted data for said electronic document in said secure data cache using said recalculated unique cryptographic key and verifying said electronic document using said decrypted data.

12. A carrier carrying processor control code to, when running, implement the method of claim 1.

13. A caching system for providing a secure data cache for data stored in an electronic document, the caching system comprising:
an input to receive data to be cached;
a processor configured to
use all or part of said received data to calculate a unique cryptographic key for said data;
encrypt all or part of said data with said unique cryptographic key; and
discard said unique cryptographic key after encryption and
an output to send said encrypted data to a data cache, with decryption of encrypted data requiring the presence of said electronic document to recalculate said unique cryptographic key from said electronic document whereby said data cache is secure.

14. A caching system according to claim 13, wherein said electronic document is an electronic identity document comprising biometric data and said system provides a secure data cache for said biometric data.

15. A caching system according to claim 14, wherein said biometric data comprises facial information and said system provides a secure data cache for said facial information.

16. A caching system according to claim 14 or claim 15, wherein said biometric data comprises fingerprint data and said system provides a secure data cache for said facial information.

17. A data retrieval system for retrieving information on an electronic document from a secure data cache created by the caching system of claim 13, the data retrieval system comprising:
an inspection system for reading some data from said electronic document; and a processor configured to:
use all or part of said read data to recalculate said unique cryptographic key for said data; and
decrypt encrypted data in said secure data cache using said recalculated unique cryptographic key, whereby data on said electronic document is retrieved from said secure data cache.

18. A verification system for verifying an electronic document, the verification system comprising:
a secure data cache created by the caching system described in claim 13;
an input to receive data from said electronic document; and
a processor configured to:
use all or part of said received data to recalculate said unique cryptographic key for said data;
decrypt encrypted data in said secure data cache using said recalculated unique cryptographic key, and
verify said electronic document using said decrypted data.

19. A verification system according to claim 18 in the form of a handheld device.

20. A verification system according to claim 18 or claim 19 wherein said secure data cache is remote from said processor and said verification system comprises a wireless connection between said processor and said secure data cache.
